(19) United States
(12) Patent Application Publication
(10) Pub. No.: US 2012/0302489 A1
(43) Pub. Date: Nov. 29, 2012

(54) FUNCTIONALIZED POLYVINYL ALCOHOL FILMS

(75) Inventors: Klin Aloysius Rodrigues, Signal Mountain, TN (US); Matthew Michael Vanderhoof, Chattanooga, TN (US)

(73) Assignee: AKZO NOBEL CHEMICALS INTERNATIONAL B.V., Amersfoort (NL)

(21) Appl. No.: 13/519,166

(22) PCT Filed: Dec. 23, 2010
(86) PCT No.: PCT/EP2010/070622

§ 371 Date: Jun. 26, 2012

Related U.S. Application Data
(60) Provisional application No. 61/290,393, filed on Dec. 28, 2009.

(51) Int. Cl. C08L 29/04; C08L 33/02; C11D 17/00

(52) U.S. Cl. 510/439; 525/57

(57) ABSTRACT

A film-forming composition includes a blend of polyvinyl alcohol and hydrophobically modified solution polymer or a water soluble polymer including an anionic ethylenically unsaturated monomer wherein the composition has a pH of about 5 or less. Further included are self-supporting materials, such as films, derived from the compositions and formulations including at least one volume-filling formulation surrounded by the self-supporting material.

### FIELD OF THE INVENTION

The present invention relates to compositions and self-supporting materials derived therefrom. More specifically, the present invention relates to compositions and self-supporting materials derived therefrom that are useful in formulations, such as unit dose formulations or agricultural formulations, which readily dissolve in liquids such as water.

### BACKGROUND OF THE INVENTION

Water soluble films have been known to be used to package unit dose formulations for a variety of applications, such as in cleaning formulations. For example, these films have been used as protective barriers around cleaning formulations during storage on the shelf. When used, the water soluble films are added into the wash where the conventional water soluble films dissolve releasing the cleaning formulation contained therein into the wash liquor. However, in such conventional films, the films themselves do not have a benefit in the wash. Therefore, there is a need for films that not only provide both the benefit of protecting the formulation as it resides on the shelf but that also provide a wash benefit in their end use.

### SUMMARY OF THE INVENTION

Accordingly, in one aspect, the present invention relates to an aqueous, liquid composition comprising a blend of polyvinyl alcohol and a hydrophobically modified solution polymer. In an embodiment, the invention also relates to a self-supporting material derived from such aqueous, liquid compositions.

In another aspect, the present invention relates to a method of producing a self-supporting material, comprising the steps of removing an amount of water from the liquid composition to form the self-supporting material.

In another aspect, the present invention relates to a self-supporting material comprising a polyvinyl alcohol and a hydrophobically modified solution polymer.

### DETAILED DESCRIPTION OF THE INVENTION

A number of water soluble polymers have been used in detergent and cleaning formulations. Such water soluble polymers are typically sodium salts of polyacrylic acid, acrylate maleate copolymers and sulfonated polymers, such as copolymers of acrylic acid and 2-acrylamido-2-methyl propane sulfonic acid as the sodium salt. Most of these formulations operate on the alkaline side of the pH range and therefore these polymers are typically neutralized to a pH of 7 or higher. It has been considered that a possible way to make polyvinyl alcohols films functional would be to introduce these water soluble polymers into the film. However, it has been found that these water soluble polymers are not compatible with the polyvinyl alcohols when neutralized to pH of 7 or higher, resulting in inhomogeneous films.

As used herein, the term “inhomogeneous film” or “incompatible film” means a film that under visual examination exhibits two or more phases wherein one phase is primarily present in concentrated areas, resulting in holes and/or pockets of generally non-uniform thickness, these areas being surrounded by at least a second phase. Inhomogeneous films may adversely affect the film's performance and would be aesthetically unacceptable to, for example, detergent manufacturers and end users.

Surprisingly, it has been found that solutions or compositions containing blends of water soluble polymers and polyvinyl alcohols with a pH of about 5 or lower (but greater than pH of about 1) produce homogenous self-supporting materials, such as solid, amorphous, gelled articles or films in which the two polymers are compatible. Additionally, it has further been found that hydrophobically modified polymers are compatible with polyvinyl alcohols when cast into films. Advantageously, because the water soluble polymer at a pH of less than 5 and/or the hydrophobically modified polymers are capable of replacing some of the water soluble polymer in the unit dose formulations, these polymers can provide dispersion, soil suspension, metal protection, anti-filming and anti-spotting performance. Consequently, the size of the unit dose capsule can be decreased or alternatively, by including such functionality into the protective barrier film layer, the capacity of the overall unit dose formulation to include other actives therein is increased.

In an embodiment of the invention, the compositions may be produced from a hydrophobically modified solution polymer derived from an anionic ethylenically unsaturated monomer and a water insoluble monomer. For purposes of this invention, the definition of solution polymer excludes emulsion or suspension polymers since these materials are higher molecular weight and do not readily dissolve when incorporated into films. These hydrophobically modified solution polymers are usually synthesized in a mixture of alcohol and water and the alcohol is removed at the end of the reaction. Also, when a self-supporting material is made using this type of polymer, the material is substantially dry and no longer a solution. Furthermore, a solution polymer as used herein means that the polymer has a solubility of at least 1% by weight in water, in another embodiment at least 10 percent by weight in water and in yet another embodiment at least 25% by weight in water at 25 C. As used herein, the term “anionic ethylenically unsaturated monomer” means an ethylenically unsaturated monomer which is capable of introducing a negative charge into the copolymer. These anionic ethylenically unsaturated monomers include, but are not limited to, acrylic acid, methacrylic acid, ethacrylic acid, α-chloro-acrylic acid, α-cyano acrylic acid, β-methyl-acrylic acid (crotonic acid), α-phenyl acrylic acid, β-acryloxy propionic acid, sorbic acid, α-chloro sorbic acid, angelic acid, cinnamic acid, p-chloro cinnamic acid, β-styryl acrylic acid (1-carboxy-4-phenyl butadiene-1,3), itaconic acid, maleic acid, citraconic acid, mesaconic acid, glutaconic acid, aconitic acid, fumaric acid, tricarboxy ethylene, muconic acid, 2-acryloxypropionic acid, 2-acrylamido-2-methyl propane sulfonic acid, vinyl sulfonic acid, sodium methallyl sulfonate, sulfonated styrene, allyloxybenzene sulfonic acid, vinyl phosphonic acid, maleic acid their salts and mixtures of two or more thereof. Moieties such as maleic anhydride or acrylamide that can be derivatized (hydrolyzed) to moieties with a negative charge are also to be interpreted as anionic ethylenically unsaturated monomers in the context of the present invention. In a preferred embodiment the anionic ethylenically unsaturated monomer is selected from the group consisting of acrylic acid, maleic acid, itaconic acid, methacrylic acid, 2-acrylamido-2-methyl propane sulfonic acid, vinyl sulfonic acid, sodium methallyl sulfonate, sulfonated styrene, allyloxybenzene sulfonic acid and mixtures of two or more thereof.

It is expected that self-supporting materials, such as films, produced from a hydrophobically modified solution polymer derived from an anionic ethylenically unsaturated monomer and a water insoluble monomer, when the aqueous solutions are dried, are particularly advantageous when the self-supporting materials are used to package an anionic formulation such as a detergent or automatic dishwash formulation.

As used herein, the term “water insoluble monomers” is defined as any ethylenically unsaturated monomer having a water solubility of less than 3 grams per 100 mls of water at 20° C. and preferably less than 1 gram per 100 mls of water at 20° C. These water insoluble monomers include, for example, ethylenically unsaturated monomers with saturated or unsaturated alkyl, hydroxyalkyl, alkylalkoxy groups, arylalkoxy, alkarylalkoxy, aryl and aryl-alkyl groups, alkyl sulfonate, aryl sulfonate, siloxane and combinations thereof. Examples of water insoluble monomers include styrene, α-methyl styrene, vinyl acetate, methyl methacrylate, methyl acrylate, 2-ethylhexyl acrylate, octyl acrylate, lauryl acrylate, stearyl acrylate, behenyl acrylate, benzyl methacrylate, 2-ethylhexyl methacrylate, octyl methacrylate, lauryl methacrylate, stearyl methacrylate, behenyl methacrylate, 2-ethylhexyl acrylamide, octyl acrylamide, lauryl acrylamide, stearyl acrylamide, behenyl acrylamide, propyl acrylate, butyl acrylate, pentyl acrylate, hexyl acrylate, 1-vinyl naphthalene, 2-vinyl naphthalene, 3-methyl styrene, 4-propyl styrene, t-butyl styrene, 4-cyclohexyl styrene, 4-dodecyl styrene, 2-ethyl-4-benzyl styrene, and 4-(phenyl butyl) styrene. Combinations of two or more water insoluble monomers can also be used. The preferred water insoluble monomers are styrene, vinyl acetate, methyl methacrylate, methyl acrylate, benzyl methacrylate, lauryl methacrylate and stearyl methacrylate. In another embodiment, the hydrophobically modified solution polymers include hybrid or graft copolymers of the anionic ethylenically unsaturated monomer and the water insoluble monomer with naturally derived hydroxyl containing materials, such as polysaccharides, oligosaccharides and saccharides. Such polymers are described in U.S. Patent Application Publication No. 2007/0021577, which is incorporated by reference in its entirety herein. In yet another embodiment of the invention, the hydrophobically modified solution polymer may be synthesized from a anionic ethylenically unsaturated monomer and a water insoluble chain transfer agent, such as n-dodecylmercaptan.

The mole % of the water insoluble monomer in the hydrophobically modified solution polymer may be preferably in the range of 2 to 80 mole %, more preferably in the range 5 to 70 mole % and most preferably in the range 10 to 60 mole %. One skilled in the art will recognize that the amount of water insoluble monomer incorporated in to the polymer will depend on the hydrophobicity of the monomer and the extent of neutralization of the resulting hydrophobically modified solution polymer. The higher the hydrophobicity of the water insoluble monomer, the lower the amount of said monomer that can be incorporated in to the polymer. Also, the higher the hydrophobicity of the water insoluble monomer, the greater the degree of neutralization of the final polymer to keep it water soluble.

In an embodiment of the invention, the self-supporting materials may be cast from an aqueous solution containing an anionic water soluble polymer and polyvinyl alcohol, the solution having a pH of less than about 5, more preferably a pH of less than about 4.75 and most preferably a pH of less than about 4.5. In addition, because the self-supporting materials are to be dissolved in the wash liquor, the materials should be cast from a solution of about pH 1 or greater. Self-supporting materials made from solutions of less than about pH 1 may be undesirably corrosive, rendering the self-supporting materials unfit for handling by the consumer or too corrosive for dishes and washing machines in such end use applications.

As used herein, the “anionic water soluble polymer” refers to a polymer that contains at least one anionic ethylenically unsaturated monomer and the polymer has a water solubility of at least about 10 weight percent at a pH of about 7 at about 25° C. In an embodiment of the invention, the anionic water soluble polymers are homopolymers of acrylic acid, maleic acid and itaconic acid, and copolymers of two or more thereof. In another embodiment, the anionic water soluble polymers may be copolymers of acrylic acid and/or maleic acid with at least one sulfonated monomer, such as 2-acrylamido-2-methyl propane sulfonic acid, vinyl sulfonic acid, methallyl sulfonic acid, allyl sulfonic acid, sulfonated styrene or allyloxybenzene sulfonic acid. In yet another embodiment, the anionic water soluble polymers may be hybrid or graft copolymers. Such hybrid copolymers are described, for example, in U.S. Patent Application Publication No. 2007/0021577 and U.S. patent application Ser. No. 12/533,802, filed Sep. 14, 2009, each of which applications is incorporated by reference in its entirety herein. Suitable graft copolymers may be those such as described in U.S. Patent Application Publication Nos. 2008/0021168, 2008/0020961(A1), 2008/0021167(A1) and 2008/0020948(A1), U.S. Pat. No. 5,760,154, U.S. Pat. No. 5,580,941, U.S. Pat. No. 5,227,446 each of which publication is incorporated by reference in its entirety herein. In an embodiment of the invention, partial neutralization to about pH 5 or below for these polymers may be performed, for example, with alkali metal hydroxides, such as sodium hydroxide, potassium hydroxide etc or amines such ethanol amine, diethanolamine and triethanol amine. In one embodiment, the anionic water soluble polymer may be neutralized by hydrophobic neutralizing agents such as hydrophobic amines. Examples of these hydrophobic amines are amines containing saturated or unsaturated alkyl, hydroxyalkyl, alkylalkoxy groups, arylalkoxy, alkarylalkoxy, aryl and aryl-alkyl groups. Examples of these hydrophobic amines include but are not limited to benzyl amine, octyl amine, lauryl amine, coco amine, oleic amine, erucyl amine, soya amine, stearylamine and behenyl amine among others. When the anionic water soluble polymer is neutralized either partially or completely with hydrophobic neutralizing agents, the resulting polymer forms a compatible film with polyvinyl alcohol even when the pH of the solution is greater than 5. In this case the pH of the solution of the 2 components is preferably greater than 9, more preferably greater than 7 and most preferably greater than 5.

In an embodiment of the invention, the weight percent of polyvinyl alcohol in the or self-supporting material is less than 60 weight percent of the self-supporting material, in another embodiment less than 25 weight percent of the self-supporting material and in yet another embodiment less than 10 weight percent of the self-supporting material. One skilled in the art will recognize that in addition to the polyvinyl alcohol and the hydrophobically modified solution polymer and/or the anionic water soluble polymer other ingredients may need to be added to the self-supporting material to improve material's properties during processing, storage on the shelf and in the final end use applications. Such ingredients are known to those of ordinary skill in the art. The composition will contain water, polyvinyl alcohol and the hydrophobically modified solution polymer and/or the anionic water soluble polymer other ingredients which is then dried to form the self-supporting material. One skilled in the art will recognize that the lower amount of water the faster the self-supporting material is formed. However, the lower the amount of water the higher the viscosity of the composition and the harder it is to handle. Therefore, the amount of water will depend on the particular application.

The polyvinyl alcohol suitable for use in the present invention is preferably prepared by the hydrolysis of polyvinyl acetate. For example, suitable polyvinyl alcohols for the present invention may be hydrolysis products of the homopolymer of polyvinyl acetate. One such exemplary polyvinyl alcohol is CELVOL® 805, which is available from Celanese Chemicals of Dallas, Tex. It is noted that while copolymers of polyvinyl acetate may be used in the present invention, these are generally not preferred. This is because such copolymers of polyvinyl acetate tend to lead to less than optimum film properties. In an embodiment of the invention, the polyvinyl alcohols have a minimum of about 85% hydrolysis of the acetate groups. In another embodiment, the polyvinyl alcohols have a minimum of about 95% hydrolysis of the acetate groups. In addition, the weight average molecular weight of the polyvinyl alcohols suitable for use in the present invention may be in the range of from about 5,000 to about 500,000, preferably in the range of from about 10,000 to about 200,000 and most preferably in the range of from about 13,000 to about 50,000.

In a further embodiment of the invention, the compositions of the present invention may be polyvinyl alcohol and a hydrophobically modified solution polymers which may be derived from a non-anionic ethylenically unsaturated monomer and a water insoluble monomer in an aqueous solution. As used herein, the term “non-anionic ethylenically unsaturated monomer” means at least one cationic or nonionic ethylenically unsaturated monomer. As used herein, the term “cationic ethylenically unsaturated monomer” means an ethylenically unsaturated monomer which is capable of introducing a positive charge to the hydrophobically modified solution polymer. Self-supporting materials, such as films, derived from the compositions when hydrophobically modified solution polymer is derived from a non-anionic ethylenically unsaturated monomer and a water insoluble monomer are particularly advantageous when the self-supporting materials are used to package a cationic formulation, such as a fabric softener formulation.

In an embodiment of the invention, the cationic ethylenically unsaturated monomer has at least one amine functionality. Cationic derivatives of these hydrophobically modified solution polymers may be formed by forming amine salts of all or a portion of the amine functionality, by quaternizing all or a portion of the amine functionality to form a quaternary ammonium salts, or by oxidizing all or a portion of the amine functionality to form N-oxide groups. As used herein, the term “amine salt” means the nitrogen atom of the amine functionality is covalently bonded to one to three organic groups and is associated with an anion. As used herein, the term “quaternary ammonium salt” means that the nitrogen atom of the amine functionality is covalently bonded to four organic groups and is associated with an anion. These cationic derivatives can be synthesized by functionalizing the monomer before polymerization or by functionalizing the polymer after polymerization.

Suitable cationic ethylenically unsaturated monomers include, but are not limited to, N,N dialkylaminoalkyl(meth)acrylate, N-alkylaminoalkyl(meth)acrylate, N,N dialkylaminoalkyl(meth)acrylamide and N-alkylaminoalkyl(meth)acrylamide, where the alkyl groups are independently C₁₋₁₈ cyclic compounds such as 1-vinyl imidazole and others. Aromatic amine containing monomers such as vinyl pyridine may also be used. Furthermore, monomers such as vinyl formamide, vinyl acetamide and the like, which generate amine moieties on hydrolysis, may also be used. Preferably, the cationic ethylenically unsaturated monomer is selected from N,N-dimethylaminoethyl methacrylate, tert-butylaminoethylmethacrylate and N,N-dimethylaminopropyl methacrylamide.

Cationic ethylenically unsaturated monomers that may be used are the quarternized derivatives of the above monomers as well as diallyldimethylammonium chloride, which is also known as dimethyldiallylammonium chloride, (meth)acrylamidopropyl trimethylammonium chloride, 2-(meth)acryloyloxy ethyl trimethyl ammonium chloride, 2-(meth)acryloyloxy ethyl trimethyl ammonium methyl sulfate, 2-(meth)acryloyloxyethyltrimethyl ammonium chloride, N,N-Dimethylaminoethyl (meth)acrylate methyl chloride quaternary, methacryloyloxy ethyl betaine as well as other betaines and sulfobetaines, 2-(meth)acryloyloxy ethyl dimethyl ammonium hydrochloride, 3-(meth)acryloyloxy ethyl dimethyl ammonium hydroacetate, 2-(meth)acryloyloxy ethyl dimethyl cetyl ammonium chloride, 2-(meth)acryloyloxy ethyl diphenyl ammonium chloride and others.

As used herein, the term “nonionic ethylenically unsaturated monomer” means an ethylenically unsaturated monomer which does not introduce a charge into the hydrophobically modified solution polymer. These nonionic ethylenically unsaturated monomers include, but are not limited to, acrylamide, methacrylamide, N alkyl(meth)acrylamide, N,N dialkyl(meth)acrylamide such as N,N dimethylacrylamide, hydroxyalkyl(meth)acrylates, alkyl(meth)acrylates, such as methylacrylate and methylmethacrylate, vinyl acetate, vinyl morpholine, vinyl pyrrolidone, vinyl caprolactum, ethoxylated alkyl, alkaryl or aryl monomers, such as methoxypolyethylene, glycol (meth)acrylate, allyl glycidyl ether, allyl alcohol, glycerol (meth)acrylate, monomers containing silane, silanol and siloxane functionalities and the like. The non ionic ethylenically unsaturated monomer is preferably water soluble. As used herein, the non ionic ethylenically unsaturated monomer has a water solubility of more than 5 grams per 100 mls of water at 20° C. and preferably more than 10 gram per 100 mls of water at 20° C.

Depending on the solubility of the water insoluble monomer, the hydrophobically modified solution polymer may need to be at least partially or fully neutralized to make it water soluble. For example, if the water insoluble monomer has a water solubility of less than 0.1 grams in 100 grams of water at 20° C. or is hydrophobic, such as styrene, and is present in the polymer in an amount of greater than 20 mole %) ratio, the water soluble monomer should be partially or fully neutralized. In an embodiment of the invention, the neutralizing agent may be inorganic or organic. One of ordinary skill in the art would recognize that the amount of water insoluble monomer will depend on the hydrophobicity of the monomer. That is, the more hydrophobic the monomer the lesser amount of the hydrophobic monomer can be incorporated in to the polymer while maintaining the requisite level of solubility. For example, methyl methacrylate may be included in an amount of from about 2 to about 80 mole % of the hydrophobically modified solution polymer. However, monomers that are relatively more hydrophobic, such as lauryl and stearyl methacrylate, maybe incorporated from about 2 to about 12 mole %.

The compositions of this invention may be produced by methods familiar to those of ordinary skill in the art. In one embodiment, an aqueous solution is first prepared by mixing the materials dissolving the poly vinylalcohol in water by heating from about 70° F. (about 21° C.) to 195° F. (about 90° C.) until solution is complete. The hydrophobically modified solution polymer or an anionic water soluble polymer is then added to this aqueous solution with mixing and heat, if necessary. The pH is adjusted to the desired pH range with acid or base. Other adjunct ingredients such as salts, plasticizers, lubricants, release agents, fillers, extenders, anti-blocking agents, detackifying agents, antifoams, or other functional ingredients may be added to the aqueous solution. The aqueous composition may have other volatile components. The composition is spread on a surface and at least a part of the water and other volatile components are then removed from the solution by conventional methods known in the art. The composition may be made into any suitable form (e.g. film or sheets) and may then be subsequently formed into any suitable product (e.g. single- and multiple-compartment pouches, sachets, bags, etc.). In another embodiment, the method of making the water-soluble film includes forming a multi-layer watersoluble film. The multi-layer water-soluble film can include two or more layers (e.g., 3, 4, 5 layers, etc.). The term “layer”, as used herein, not only encompasses pre-formed layers, but also encompasses coatings. A layer can be applied in a single step, or multiple application steps can be used to build up a suitable layer.

It is desirable that the self-supporting materials according to the present invention rapidly dissolve when introduced, for example, into the wash liquor. It has been found that the lower the molecular weight of the hydrophobically modified solution polymer or the anionic water soluble polymer in the composition, the faster the self-supporting material will dissolve. Therefore, in embodiments of the present invention, the hydrophobically modified solution polymer or the anionic water soluble polymer has a number average molecular weight of less than about 25,000 daltons, preferably less than about 10,000 daltons, and most preferably less than about 5,000 daltons based on a polyacrylic acid standard.

The solubility of the self-supporting material, for example in the form of a film, may be measured by determining the time it takes for 0.03 grams of a 7.5 mil thick film to dissolve in 100 grams of water which is used to determine the time required for a water-soluble film to break apart (disintegrate) and its subsequent relative dissolution time when held stationary. The procedure for determining solublility is described in more detail in Example 8. According to an embodiment of the present invention, when the film has a film thickness of about 7.5 mils (1 mil=0.001 inch), the film dissolves in less than about 500 seconds at about 25° C. in distilled water. In another embodiment, the film dissolves in less than about 300 seconds at about 25° C. in distilled water and more preferably dissolves in less than about 150 seconds at about 25° C. in distilled water.

It is also desirable that the self-supporting materials of the present invention have adequate strength, for example in detergent formulation applications, to contain the detergent formulation within the material's barrier without releasing the detergent formulation prematurely while the unit dost formulation is stored on the shelf. The strength of the material may be measured by ASTM D882, which is incorporated by reference herein. Accordingly, in an embodiment of the invention, the self-supporting material is an article of manufacture in the form of a film. In such an embodiment, the films have a tensile strength of at least about 1000 psi at a film thickness of about 7.5 mils. In another embodiment, the films have a tensile strength of at least about 2000 psi at a film thickness of about 7.5 mils. In a further embodiment, the films have a tensile strength of at least about 3000 psi at a film thickness of about 7.5 mils.

In certain applications, it is also desirable that in addition to the aforementioned physical properties, the films should not susceptible to humidity during storage. Therefore, in an embodiment of the invention, when the films have a film thickness of about 7.5 mils, the films absorb less than about 30 percent, preferably less than about 20 percent, and more preferably less than about 10 percent of their weight in moisture over a 24 hour period at 80° F. and 65% relative humidity.

In addition, the protective properties of the film and the solubility of the film in the wash may depend on the weight percent of hydrophobically modified solution polymer or the anionic water soluble polymer in the film-forming composition, which when dried forms the film. Accordingly, in an embodiment of the invention, the hydrophobically modified solution polymer or the anionic water soluble polymer is at least about 5 weight percent of the blend, more preferably at least about 10 weight percent of the blend and even more preferably at least about 20 weight percent of the blend. In another embodiment, the hydrophobically modified solution polymer or the anionic water soluble polymer is about 95 weight percent of the blend or less, more preferably about 90 weight percent of the blend or less and even more preferably about 80 weight percent of the blend or less. It is understood that a combination of polyvinyl alcohol, hydrophobically modified solution polymer and anionic water soluble polymer can also be used to make exemplary films or blends.

In another aspect, the present invention relates to articles of manufacture, such as in unit dose formulations and/or powder detergent formulations, in which at least one volume-filling formulation, for example comprising an active ingredient (e.g. a core material), is coated by a self-supporting material that acts as a protective barrier (e.g. an encapsulating material or coating). Accordingly, in an embodiment according to this aspect, the coated particle comprises at least one volume-filling formulation, such as an active ingredient, coated by a film. In an embodiment of the invention, the volume-filling formulation is a liquid. The self-supporting material is derived from an aqueous, liquid composition comprising a blend of polyvinyl alcohol and hydrophobically modified solution polymer or a comprising a blend of polyvinyl alcohol and water soluble anionic polymer cast from a solution of pH 5 or lower. The term “coated particles” is meant to denote all active ingredients (e.g. powder, granules, liquids or volatile compounds) as the core which have been encapsulated or coated or surrounded by at least one other material, i.e. the coating.

The coating surrounding the active ingredient will act to sufficiently delay the active ingredient from directly contacting the environment external to the coating. At the same time the coating layer is sufficiently readily dissolvable to release the active agent in the final application. Further, the particle once formulated may also provide a stable particle size that will not change during storage or transportation, and/or be formulated by including additional ingredients in the film layer to protect the core (active ingredients) from the effects of UV rays, moisture, and oxygen. Depending on the active ingredient, chemical reactions between incompatible species of different active ingredients if multiple active ingredients are used may also be prevented due to the coating. The formulations of the present invention exhibit greatly improved storage, handling, and manufacturing properties.

In another embodiment, the article of manufacture is a detergent formulation which comprises at least one active ingredient and a film surrounding a detergent active ingredient. In an embodiment of the invention, the film derived is from a film-forming composition comprising a blend of polyvinyl alcohol and a water soluble polymer comprising an anionic ethylenically unsaturated monomer in an aqueous solution, wherein the composition has a pH of about 5 or less. In an alternative embodiment, the film is derived from a film-forming composition comprising a blend of polyvinyl alcohol and a hydrophobically modified polymer. Suitable detergent active ingredients may include, for example, surfactants, builders, phosphates, sodium carbonate, citrates, enzymes, buffers, perfumes, anti-foam agents, ion exchangers, alkalis, anti-redeposition materials, optical brighteners, fragrances, dyes, fillers, chelating agents, fabric whiteners, brighteners, sudsing control agents, solvents, hydrotropes, bleaching agents, bleach precursors, buffering agents, soil removal agents, soil release agents, fabric softening agent, opacifiers, corrosion inhibitors, zinc compounds, tolyltriazole, minerals, clays, and salts. The surfactants can be anionic, non-ionic, such as low foaming non-ionic surfactants, cationic or zwitterionic. In an embodiment of the invention, the chelants may be glutamic acid N,N-diacetic acid (GLDA) and methylglycine N,N-diacetic acid (MGDA) and others.

The detergent formulations that the self-supporting materials of the present invention can be used in include laundry and automatic dishwash (ADW) formulations as well as rinse aids for automatic dishwashing machines. In an exemplary embodiment, for automatic dishwashing detergent formulations, such formulations include phosphate, low phosphate and “zero” phosphate built formulations, in which the detergent is substantially free of phosphates. As used herein, in an embodiment of the invention, low phosphate means less than 1500 ppm phosphate in the wash, in another embodiment less than about 1000 ppm phosphate in the wash, and in still another embodiment less that 500 ppm phosphate in the wash. Detergent formulations having phosphate levels in the wash are below about 100 ppm are to be understood to mean substantially free of phosphates.

In one embodiment of the invention, a film made from a blend of polyvinyl alcohol and a water soluble polymer comprising an anionic ethylenically unsaturated monomer in an aqueous solution, wherein the composition has a pH of about 5 may be used to protect the detergent part of the automatic dishwash formulation and a film made from a blend of polyvinyl alcohol and a hydrophobically modified polymer may be used to protect the rinse aid portion of the same unit dose formulation. It is generally desirable that the rinse aid be introduced in to the wash at a later time than the detergent part of the formulation. This can be achieved in a number of ways, such as making a thicker film or using a more hydrophobic polymer to make the film such that the film dissolves slower. In an embodiment of the invention, the self-supporting material, such as a film, made from the blend of aforementioned polymers is substantially free of crosslinkers. This is due to the fact that crosslinking of the material adversely affects its solubility rate. For purposes of this invention, a crosslinker is defined as any material that can react with 2 or more hydroxyl groups of the polyvinyl alcohol, such as boric acid compounds and sodium borate. Substantially free means that the self-supporting material has less than 0.1 weight percent of crosslinker by weight of the self-supporting material and preferably has none.

The compositions of the present invention may further include other additional ingredients, such as water, salts, plasticizers, lubricants, release agents, fillers, extenders, anti-blocking agents, de-tackifying agents, antifoams, or other ingredients. Suitable salts may include organic or inorganic electrolytes.

Suitable salts may include a cation or mixtures of cations selected from the following group: aluminum, ammonium, antimony, barium, bismuth, cadmium, calcium, cesium, copper, iron, lithium, magnesium, nickel, potassium, rubidium, silver, sodium, strontium, zinc and zirconium; and an anion or mixture of anions selected from the following group: acetate, aluminum sulfate, azide, bicarbonate, bisulfite, borohydride, borooxalate, bromate, bromide, carbonate, chloride, chlorite, chromate, cyanate, cyanide, dichromate, disilicate, dithionate, ferricyanide, ferro cyanate, ferrocyanide, fluoride, fluoroantimonate, fluoroborate, fluorophosphate, fluorosulfonate, fluorosilicate, hydrogen carbonate, hydrogen sulfate, hydrogen sulfite, hydrogencyanide, hydrogen phosphate, hydrogen sulfate, hydro sulfite, hydroxide, hydroxyostannate, hypochlorite, hyponitrite, hypophosphite, iodate, iodide, manganate, meta-aluminate, metaborate, metaperiodate, metasilicate, mixed halides, molybdate, nitrate, nitrite, orthophosphate, orthophosphite, orthosilicate, oxalate, oxalatoferrate, oxide, perborate, perchlorate, permanganate, peroxide, peroxydisulfate, phosphate, polybromide, polychloride, polyfluoride, polyiodide, polyphosphate, poly sulfide, pyrosulfate, pyrosulfite, sesquicarbonate, silicate, stannate, sulfamate, sulfate, sulfide, sulfite, thiocyanaate or thiosulfate.

Suitable plasticizers include, but are not limited to: glycerol, glycerin, diglycerin, hydroxypropyl glycerine, sorbitol, ethylene glycol, diethylene glycol, triethylene glycol, tetraethylene glycol, propylene glycol, polyethylene glycols, neopentyl glycol, trimethylolpropane, polyether polyols, ethanolamines, and mixtures thereof.

It is also contemplated that the compositions of the present invention may find uses in other applications. One such application is the Agricultural area in which the compositions of this invention may be used to make articles of manufacture in which self-supporting materials are used to encapsulate agrochemical actives as the volume-filling formulations. The self-supporting materials may be films, which can be used to protect volume-filling formulations, such as detergent actives or agrochemical actives from each other or to protect the actives from the environment or to protect the user during handling.

As used herein, the term “agrochemical active” means any material that is used in agricultural applications. These include, but are not limited to, formulations including herbicides, insecticides, fungicides, biocides, molluscicides, algaicides, plant growth regulators, anthelmintics, rodenticides, nematocides, acaricides, amoebicides, protozoacides, crop safeners and adjuvants. In an embodiment of the invention, the agrochemical active may be a water insoluble or immiscible material.

In another embodiment, the agrochemical active may be water-soluble. Examples of water soluble agrochemical actives include but are not limited to Clopyralid, Imazethapyr, Paraquat, Dicamba, Bentazone, glyphosate, glufosinate and others. Among such water soluble active materials are, non-selective herbicides, particularly N-(phosphono-methyl)glycine type herbicides, such as glyphosate and sulphosate {respectively the iso-propyl-amino and trimethylsulphonium salts of N-phosphonomethyl glycine} and phosphinyl amino acids, such as glufosinate {2-amino-4-(hydroxymethylphosphinyl) butanoic acid}, particularly as the ammonium salt.

Alternatively, the compositions of the invention may be used to make self-supporting materials, such as films, to encase agrochemical formulations. These formulations can be in a dry form or in the form of a non aqueous/oil based liquid. These formulations are well known in the art. The non aqueous formulations may contain the agrochemical active dissolved or dispersed in an oil, such as a vegetable oil or an aromatic solvent or mixtures of thereof two.

The dry formulations can be wettable powders (WP) or water dispersable granules (WDG). The formulations encased in these films may be added to a dilution tank containing water. In these embodiments, the films dissolve in this aqueous media releasing the actives in the formulation. The hydrophobically modified solution polymer or the water soluble polymer comprising an anionic ethylenically unsaturated monomer is released in to this dilution tank and helps disperse the actives in the tank. Thus, a part of the film becomes functional in the final application.

In another embodiment of this invention, the films of this invention may be used to encapsulate a volume-filling formulation that contains a non aqueous liquid. These non aqueous liquids are any solvents besides water which include but are not limited to glycols, glycol ethers, vegetable oils and aromatic solvents.

### EXAMPLES

The following examples are intended to exemplify the present invention but are not intended to limit the scope of the invention in any way. The breadth and scope of the invention are to be limited solely by the claims appended hereto.

### Example 1

### Preparation of a Hydrophobically Modified Solution Polymer Containing 60 mole Percent Acrylic Acid (Anionic Ethylenically Unsaturated Monomer) and 40 mole Percent Styrene (Water Insoluble Monomer)

An initial charge of 86.4 g of deionized water, 79.2 g of isopropyl alcohol, and 0.042 grams of ferrous ammonium sulfate were added to a 1 liter glass reactor. The reactor contents were heated to reflux (approximately 84° C.).

At reflux, continuous additions of 64.5 g of acrylic acid, 62.1 g of styrene, 0.1 g of dodecylmercaptan were added over a period of 3.5 hours. The initiator and chain transfer solutions were added at the same time as the above described monomer solution over a period of 4 hours and 3.25 hours, respectively.

Initiator solution

| | |
|---|---|
| Sodium persulfate | 5.72 g |
| Water | 14.0 g |
| Hydrogen peroxide 35% | 16.7 g |

Chain transfer solution

| | |
|---|---|
| 3-mercapto propionic acid, 99.5% | 4.9 g |
| water | 21.8 g |

After adding the initiator and chain transfer solutions, the reaction temperature was maintained at about 88° C. for one hour. The alcohol cosolvent was removed from the polymer solution by azeotropic distillation under vacuum. During the distillation, a mixture of 144 g of deionized water and 64.1 g of a 50 percent sodium hydroxide solution was added to the polymer solution. A small amount of ANTIFOAM 1400 (0.045 g) was added to suppress any foam generated during distillation. Approximately, 190 g of a mixture of water and isopropyl alcohol were distilled off. After distillation was completed, 25 g of water was added to the reaction mixture which was cooled to obtain a yellowish amber solution. The number average molecular weight of this polymer is around 2,000 daltons.

### Example 2

### Preparation of Hydrophobically Modified Solution Polymer Containing 49 mole Percent Acrylic Acid and 51 mole Percent Styrene

An initial charge of 195.2 g of deionized water, 279.1 g of isopropyl alcohol, and 0.0949 grams of ferrous ammonium sulfate were added to a 1 liter glass reactor. The reactor contents were heated to reflux (approximately 84° C.).

At reflux, continuous additions of 121.4 g of acrylic acid, 175.5 g of styrene, were added over a period of 3.5 hours. The initiator and chain transfer solutions were added at the same time as the above described monomer solution over a period of 4 hours and 3.25 hours, respectively.

Initiator solution

| | |
|---|---|
| Sodium persulfate | 12.93 g |
| Water | 31.6 g |
| Hydrogen peroxide 35% | 37.8 g |

Chain transfer solution

| | |
|---|---|
| 3-mercapto propionic acid, 99.5% | 11.1 g |
| water | 49.3 g |

After adding the initiator and chain transfer solutions, the reaction temperature was maintained at about 88° C. for one hour. The alcohol cosolvent was removed from the polymer solution by azeotropic distillation under vacuum. During the distillation, a mixture of 325.6 g of deionized water and 134.8 g of a 50 percent sodium hydroxide solution was added to the polymer solution. A small amount of ANTIFOAM 1400 (0.10 g) was added to suppress any foam generated during distillation. Approximately, 375.0 g of a mixture of water and isopropyl alcohol were distilled off. After distillation was completed, 25 g of water was added to the reaction mixture which was cooled to obtain a yellowish amber solution. The number average molecular weight of this polymer is around 1,900 daltons.

### Example 3

Example 2 was repeated but with using 60 mole percent styrene and 40 mole percent acrylic acid. An initial charge of 195.2 g of deionized water, 279.1 g of isopropyl alcohol, and 0.0949 grams of ferrous ammonium sulfate were added to a 1 liter glass reactor. The reactor contents were heated to reflux (approximately 84° C.).

At reflux, continuous additions of 97.1 g of acrylic acid, 210.6 g of styrene, were added over a period of 3.5 hours. The initiator and chain transfer solutions were added at the same time as the above described monomer solution over a period of 4 hours and 3.25 hours, respectively.

Initiator solution

| | |
|---|---|
| Sodium persulfate | 12.93 g |
| Water | 31.6 g |
| Hydrogen peroxide 35% | 37.8 g |

Chain transfer solution

| | |
|---|---|
| 3-mercapto propionic acid, 99.5% | 11.1 g |
| water | 49.3 g |

After adding the initiator and chain transfer solutions, the reaction temperature was maintained at about 88° C. for one hour. The alcohol cosolvent was removed from the polymer solution by azeotropic distillation under vacuum. During the distillation, a mixture of 325.6 g of deionized water and 107.8 g of a 50% sodium hydroxide solution was added to the polymer solution. A small amount of ANTIFOAM 1400 (0.10 g) was added to suppress any foam generated during distillation. Approximately, 375.0 g of a mixture of water and isopropyl alcohol were distilled off. After distillation was completed, 25 g of water was added to the reaction mixture which was cooled to obtain an amber solution. The number average molecular weight of this polymer is around 2,200 daltons.

### Example 4

### Preparation of Hydrophobically Modified Solution Polymer Containing 96.1 mole Percent Acrylic Acid and 3.9 mole Percent Laurylmethacrylate

An initial charge of 190 g of deionized water and 97.1 g of isopropyl alcohol were added to a 1 liter glass reactor. The reactor contents were heated to reflux (approximately 82° C.-84° C.). At reflux continuous additions of 105 g of acrylic acid, and 15.0 g of laurylmethacrylate were added to the reactor concurrently over a 3 hour period of time with stirring. Concurrently, an initiator solution containing 15.9 g of sodium persulfate and 24.0 g of water was added over a period of 4 hours.

The reaction temperature was maintained at about 82° C.-85° C. for an additional hour. The alcohol cosolvent was removed from the polymer solution by azeotropic distillation under vacuum. During the half-way point of the distillation (when approximately 100 g of distillate is producted), 48 g of hot water was added to the polymer solution to maintain a reasonable polymer viscosity. A small amount of ANTIFOAM 1400 (0.045 g) was added to suppress any foam that may be generated during distillation. Approximately, 200 g of a mixture of water and isopropyl alcohol was distilled off. The distillation was stopped when the isopropyl alcohol level in the reaction product was less than 0.3 weight percent.

The reaction mixture was cooled to less than 40° C. and 45 g of water and 105.8 g of a 50% NaOH was added to the reaction mixture with cooling while maintaining a temperature of less than 40° C. to prevent hydrolysis of the laurylmethacrylate. The final product was an opaque viscous liquid. The number average molecular weight of this polymer is around 2,900 daltons.

### Example 5

### Synthesis of Hydrophobically Modified Solution Polymer Namely Polyacrylic Acid with a C₁₂ Chain Transfer Agent

524.8 g of water and 174 g of isopropyl alcohol were heated in a reactor to 85° C. A mixture of 374 g of acrylic acid and 49 g of n-dodecylmercaptan were added to the reactor over a period of three hours. After addition was completed, 65.3 g of acrylic acid was added over a period of 30 minutes to the reactor. At the same time, a solution of 17.5 g of sodium persulfate in 175 g of water was added to the reactor over a period of four hours. The temperature of the reactor was maintained at 85-95° C. for one hour, after which time, 125 g of water, 51 g of a 50% NaOH solution, and 0.07 g of ANTIFOAM 1400, available from Dow Chemical Company, were added to the reactor. The reaction mixture was distilled to remove the isopropyl alcohol. Approximately 300 g of a mixture of isopropyl alcohol and water were distilled off. The reaction mixture was cooled to room temperature and 388 g of a 50% NaOH solution was added. The number average molecular weight of this polymer is around 2,500 daltons.

### Example 6

### Synthesis of Hydrophobically Modified Solution Polymer of Acrylic Acid and Vinyl Acetate (Water Insoluble Monomer Soluble at 2 Gram in 100 ml of Water at 20° C.)

An initial charge of 1000 g of water was added to a 2 liter glass reactor and heated to 78° C. Then a mixture of 220 g of acrylic acid, and 52.0 g of vinyl acetate was added to the reactor over a 3 hour period of time with stiffing. Concurrently, an initiator solution containing 1.7 g of sodium persulfate and 190.0 g of water was added over a period of 3 hours. The reaction mixture was then heated at 85° C. for 1 hour.

### Example 7

### Preparation of a Hydrophobically Modified Solution Polymer Containing Acrylic Acid and Methyl Methacrylate (Water Insoluble Monomer)

The sample of Example 6 was repeated except that methyl methacrylate was used to replace vinyl acetate in the recipe.

### Example 8

### Creating a Film and Testing its Solubility and Moisture Uptake

1 gram of polyvinyl alcohol (CELVOL® 805) was dispersed into 50 grams of water at room temperature. The percent hydrolysis of this polyvinyl alcohol was 88% and the weight average molecular weight was approximately 40,000. The solution was heated to 95° C. 2.48 grams of solution of Example 2 was heated to 40° C. and poured into the polyvinyl alcohol solution above with stiffing. The solution was poured into a Teflon® fluoropolymer baking pan (18×18×6 cm) and allowed to dry overnight. A translucent homogeneous film of thickness 7.5 mils was formed. 0.03 grams of the film above was introduced into 100 grams of deionized water with stirring. The time required to completely dissolve the film was 135 seconds.

1.3 grams of the film above was stored at 80 F in a 65% humidity chamber for 24 hours. The weight gain of the film was measured at the end of 24 hours. The films had 0% weight gain after 24 hours indicating that these films are not susceptible to humidity which improves the shelf life of the unit dose formulations encased by these films. The tensile strength of this film was determined (qualitatively) to be the same or nearly the same as that exhibited by commercially available films which were known to be in the range of 1000 to 2000 psi.

### Example 9

1 gram of polyvinyl alcohol (CELVOL® 805) was dispersed into 50 grams of water at room temperature. The solution was heated to 95° C. 2.86 grams of solution of Example 1 was heated to 40° C. and poured into the polyvinyl alcohol solution above with stirring. The solution was poured into a Teflon® fluoropolymer baking pan (18×18×6 cm) and allowed to dry overnight. A translucent homogeneous film of thickness 7 mil was formed.

### Example 10

1 gram of polyvinyl alcohol (CELVOL® 805) was dispersed into 50 grams of water at room temperature. The solution was heated to 95° C. 2.46 grams of solution of Example 3 was heated to 40° C. and poured into the polyvinyl alcohol solution above with stirring. The solution was poured into a Teflon® fluoropolymer baking pan (18×18×6 cm) and allowed to dry overnight. A translucent homogeneous film of thickness 7 mil was formed.

### Example 11

To the hot reaction product at 85° C. of Example 6, 140 grams of polyvinyl alcohol (CELVOL® 502) was added and stirred for 60 minutes. The percent hydrolysis of this polyvinyl alcohol was 88% and the weight average molecular weight was approximately 20,000. 20 grams of this solution was and cooled to 40° C. and diluted with 10 grams of water. This solution was poured in to a Teflon® fluoropolymer baking pan (18×18×6 cm) and allowed to dry overnight. A clear homogenous film of thickness 7 mils was formed.

### Example 12

### Synthesis of Hydrophobically Modified Solution Polymer Non-Anionic Ethylenically Unsaturated Monomer and a Water Insoluble Monomer

200 g of isopropyl alcohol were heated in a reactor to 82° C. A mixture of 100 g of dimethylaminoethyl methacrylate (non-anionic ethylenically unsaturated monomer) and 6.25 g of lauryl methacrylate (water insoluble monomer) were added to the reactor over a period of 1.5 hours. At the same time, a solution of 4.25 g of tert butyl peroxy 2-ethylhexanoate in 50 g of isopropyl alcohol was added to the reactor over a period of 2 hours. The temperature of the reactor was maintained at 82° C. for one half hour, after which time, 15.4 grams of concentrated sulfuric acid dissolved in 250 g of water was added to the reactor. 0.07 g of ANTIFOAM 1400, available from Dow Chemical Company, was then added to the reactor. The reaction mixture was distilled to remove the isopropyl alcohol/water azeotrope. Approximately 339 g of a mixture of isopropyl alcohol and water were distilled off. The reaction mixture was diluted with 150 grams of water. The final product was a clear pink solution with a solids content of 27.9% and a pH of 7.8. The number average molecular weight of this polymer is around 2,000 daltons.

### Example 13

### Synthesis of Hydrophobically Modified Solution Polymer Non-Anionic Ethylenically Unsaturated Monomer and a Water Insoluble Monomer

200 g of isopropyl alcohol were heated in a reactor to 82° C. A mixture of 100 g of dimethylaminoethyl methacrylate (non-anionic ethylenically unsaturated monomer) and 8.32 g of stearyl methacrylate (water insoluble monomer) were added to the reactor over a period of 1.5 hours. At the same time, a solution of 4.25 g of tert butyl peroxy 2-ethylhexanoate in 50 g of isopropyl alcohol was added to the reactor over a period of 2 hours. The temperature of the reactor was maintained at 82° C. for one half hour, after which time, 15.4 grams of concentrated sulfuric acid dissolved in 250 g of water was added to the reactor. 0.07 g of ANTIFOAM 1400, available from Dow Chemical Company, was then added to the reactor. The reaction mixture was distilled to remove the isopropyl alcohol/water azeotrope. Approximately 315 g of a mixture of isopropyl alcohol and water were distilled off. The reaction mixture was diluted with 150 grams of water. The final product was a slightly opaque pink solution with a solids content of 27.8% and a pH of 7.5.

### Example 14

### Synthesis of Hydrophobically Modified Solution Polymer Non-Anionic Ethylenically Unsaturated Monomer and a Water Insoluble Monomer

200 grams of water, 150 g of isopropyl alcohol and 18.72 grams of concentrated sulfuric acid were added to a reactor and heated to 82° C. A mixture of 66.6 g of dimethylaminoethyl methacrylate (non-anionic ethylenically unsaturated monomer) and 42.5 g of methyl methacrylate (water insoluble monomer) were added to the reactor over a period of 1.5 hours. At the same time, a solution of 3.75 g of sodium persulfate dissolved in 40 g of water was added to the reactor over a period of 2 hours. The temperature of the reactor was maintained at 82° C. for one half hour. Next a solution of 1.0 gram of sodium persulfate dissolved in 10 g of water was added to the reactor over a period of 0.5 hours. The reaction mixture was distilled to remove the isopropyl alcohol/water azeotrope. Approximately 212 g of a mixture of isopropyl alcohol and water were distilled off. The reaction mixture was diluted with 225 grams of water. The final product was a clear water white solution with a solids content of 24.8% and a pH of 4.8.

### Example 15

### Synthesis of Hydrophobically Modified Solution Polymer Non-Anionic Ethylenically Unsaturated Monomer and a Water Insoluble Monomer

200 grams of water, 150 g of isopropyl alcohol and 33.7 grams of concentrated sulfuric acid were added to a reactor and heated to 82° C. A mixture of 106.7 g of dimethylaminoethyl methacrylate (non-anionic ethylenically unsaturated monomer) and 17.7 g of styrene (water insoluble monomer) were added to the reactor over a period of 1.5 hours. At the same time, a solution of 3.75 g of sodium persulfate dissolved in 40 g of water was added to the reactor over a period of 2 hours. The temperature of the reactor was maintained at 82° C. for one half hour. Next a solution of 1.0 gram of sodium persulfate dissolved in 10 g of water was added to the reactor over a period of 0.5 hours. The reaction mixture was distilled to remove the isopropyl alcohol/water azeotrope. Approximately 195 g of a mixture of isopropyl alcohol and water were distilled off. The reaction mixture was diluted with 200 grams of water and the final product had a solids content of 28.6% and a pH of 2.8.

### Example 16

### Synthesis of Hydrophobically Modified Solution Polymer Non-Anionic Ethylenically Unsaturated Monomer and a Water Insoluble Monomer

200 grams of water, 150 g of isopropyl alcohol and 25.0 grams of concentrated sulfuric acid were added to a reactor and heated to 82° C. A mixture of 88.95 g of dimethylaminoethyl methacrylate (non-anionic ethylenically unsaturated monomer) and 49.9 g of benzyl methacrylate (water insoluble monomer) were added to the reactor over a period of 1.5 hours. At the same time, a solution of 3.75 g of sodium persulfate dissolved in 40 g of water was added to the reactor over a period of 2 hours. The temperature of the reactor was maintained at 82° C. for one half hour. Next a solution of 1.0 gram of sodium persulfate dissolved in 10 g of water was added to the reactor over a period of 0.5 hours. The reaction mixture was distilled to remove the isopropyl alcohol/water azeotrope. Approximately 159 g of a mixture of isopropyl alcohol and water were distilled off. The reaction mixture was diluted with 225 grams of water. The final product was an opaque white solution with a solids content of 26.8% and a pH of 5.8.

### Example 17

5 grams of polyvinyl alcohol (CELVOL® 805) was dispersed into 50 grams of water at room temperature. The solution was heated to 95 C. 17.92 grams of solution of Example 12 (R7-32-134) was heated to 4° C. and poured into the polyvinyl alcohol solution above with stirring. The pH of the solution was 6.5. The solution was poured into a Teflon® fluoropolymer baking pan (18×18×6 cm) and allowed to dry overnight. A translucent compatible homogeneous film of thickness 0.040 inches was formed.

### Example 18

5 grams of polyvinyl alcohol (CELVOL® 805) was dispersed into 50 grams of water at room temperature. The solution was heated to 95 C. 18.05 grams of solution of Example 13 (R7-32-135) was heated to 4° C. and poured into the polyvinyl alcohol solution above with stirring. The pH of the solution was 7.33. The solution was poured into a Teflon® fluoropolymer baking pan (18×18×6 cm) and allowed to dry overnight. A translucent compatible homogeneous film of thickness 0.040 inches was formed.

### Example 19

Four solutions were produced, each containing 5 grams of polyvinyl alcohol (CELVOL® 805) that was dispersed into 50 grams of water at room temperature. The solutions were heated to 95° C. Next the pH (with a starting pH of 2.8) of a 50% solution of polyacrylic acid (ALCOSPERSE® 602A from AkzoNobel Surface Chemistry, Chattanooga Tenn.), was adjusted to pH 3.5, 4.5, and 5.5 with 50% NaOH solution. The number average molecular weight of this polymer is around 1,900 daltons. The amounts of these pH modified water soluble polymer solutions added to the polyvinyl alcohol solution above are listed in Table 1 below. These pH modified water soluble polymer solutions were first heated to 40° C. and then poured into the polyvinyl alcohol solutions above with stiffing. The final pH of these solutions was measured and are detailed in Table 1 below. The solutions were poured into individual Teflon® fluoropolymer baking pans (18×18×6 cm) and allowed to dry overnight. The resulting films were visually examined for compatibility.

The results were as follows:

TABLE 1

| | Amount of pH | Final pH of | |
|---|---|---|---|
| pH of water | modified water | blend of pH | |
| soluble Polymer | soluble polymer | modified water | |
| solution after | solutions added to 5 | soluble | |
| adjustment with | g PVOH in 50 grams | polymer and | |
| NaOH | water (in grams) | PVOH solution | Resulting Film |
| 2.8 | 10.47 g | 3.23 | 0.040 in Translucent compatible homogeneous |
| 3.5 | 10.73 g | 3.8 | 0.040 in Translucent compatible homogeneous |
| 4.5 | 10.91 g | 4.77 | Non-compatible splotchy inhomogeneous |
| 5.5 | 11.27 g | 5.88 | Non-compatible splotchy inhomogeneous |

These data indicate that films made out of a solution containing polyvinyl alcohol and polyacrylic acid of pH 4.75 or below are homogenous. However, films made with a solution containing polyvinyl alcohol and polyacrylic acid of pH above 4.75 showed signs of incompatibility of the 2 polymer components resulting in inhomogeneous films.

### Example 20

Four solutions were produced, each containing 5 grams of polyvinyl alcohol (CELVOL® 805) that was dispersed into 50 grams of water at room temperature. The solutions were heated to 95° C. Next the pH (with a starting pH of 4) of a 44% solution of acrylic acid and sodium acrylamido-2-methyl propane sulfonate (AQUATREAT® 545 from AkzoNobel Surface Chemistry, Chattanooga Tenn.), was adjusted to pH 5, 5.5, 6 and 7 with 50% NaOH solution. The number average molecular weight of this polymer is around 4,500 daltons. The amounts of these pH modified water soluble polymer solutions added to the polyvinyl alcohol solution above are listed in Table 2 below. These pH modified water soluble polymer solutions were first heated to 40° C. and then poured into the polyvinyl alcohol solutions above with stiffing. The final pH of each of these solutions was measured and is detailed in Table 2 below. The solutions were poured into individual Teflon® fluoropolymer baking pans (18×18×6 cm) and allowed to dry overnight. The resulting films were visually examined for compatibility.

The results were as follows:

TABLE 2

| | Amount of pH | Final pH of | |
|---|---|---|---|
| pH of water | modified water | blend of pH | |
| soluble Polymer | soluble polymer | modified water | |
| solution after | solutions added to 5 | soluble | |
| adjustment with | g PVOH in 50 grams | polymer and | |
| NaOH | water (in grams) | PVOH solution | Resulting Film |
| 4 | 11.38 g | 4.6 | 0.040 in Translucent compatible homogeneous |
| 5 | 13.80 g | 5.0 | Non-compatible splotchy inhomogeneous |
| 5.5 | 13.98 g | 5.84 | Non-compatible splotchy inhomogeneous |
| 6 | 14.16 g | 6.52 | Non-compatible splotchy inhomogeneous |
| 7 | 12.68 g | 7.74 | Non-compatible splotchy inhomogeneous |

These data indicate that films made out of a solution containing polyvinyl alcohol and a copolymer of acrylic acid and sodium acrylamido-2-methyl propane sulfonate of pH below 5 are homogenous. However, films made with a solution containing polyvinyl alcohol and polyacrylic acid of pH above 4.75 showed signs of incompatibility of the 2 polymer components resulting in inhomogeneous films that cannot be used in commercial applications.

### Example 21

### Synthesis of an Anionic Water Soluble Polymer which is a Hybrid Copolymer

30.6 grams of monomethylmaleate (ester monomer) was dissolved in 250 grams of water. 3.5 grams of 50% NaOH was added and the mixture was heated to 87° C. 170 grams of maltodextrin of DE 18 (Cargill MD™ 01918, spray-dried maltodextrin obtained by enzymatic conversion of common corn starch, available from Cargill Inc., Cedar Rapids, Iowa) was added just before the monomer and initiator feeds were started. A monomer solution containing a mixture of 112 grams of acrylic acid and 27 grams of hydroxypropyl methacrylate was added to the reactor over a period of 5 hours. A first initiator solution comprising of 21 grams of erythorbic acid dissolved in 99 grams of water was added over a period of 5.5 hours. A second initiator solution comprising of 21 grams of a 70% solution of tertiary butyl hydroperoxide dissolved in 109 grams of water was added over a period of 5.5 hours. The reaction product was held at 87° C. for 60 minutes. The final product was a clear yellow solution of about 44% solids content. The number average molecular weight was 2,180 based on a polyacrylic acid standard.

### Example 22

### Synthesis of an Anionic Water Soluble Polymer which is a Graft Copolymer

A reactor containing 965 grams of water, 132 grams of maleic anhydride, 135 grams of 50% NaOH, 0.06 grams of ferrous ammonium sulfate hexahydrate and 613 grams of maltodextrin of DE 18 was heated to 95° C. A solution containing 198 grams of acrylic acid and 25 grams of water was added to the reactor over a period of 4 hours. An initiator solution comprising 116 grams of 35% hydrogen peroxide and 14 grams of sodium persulfate dissolved in 60 grams of water was simultaneously added to the reactor over a period of 4 hours and 15 minutes. The reaction product was held at 95° C. for an additional hour. The final product was a clear light amber solution of about 45% solids.

### Example 23

### Synthesis of a Hydrophobically Modified Solution Polymer which is a Hybrid Copolymer

121 grams of maltodextrin of DE 10 was dissolved in 300 grams of water and heated to 85 C. A monomer solution containing a mixture of 85 grams of acrylic acid and 21 grams of styrene was added to the reactor over a period of 60 minutes. An initiator solution comprising of 4.8 grams of sodium persulfate dissolved in 99 grams of water was added over a period of 70 minutes. The reaction product was held at 85° C. for 60 minutes. A solution of 85 grams of sodium persulfate dissolved in 300 grams of water was added to the reactor with cooling. The final product was an opaque yellow solution with 23% solids and a pH of 7.

### Example 24

Four solutions were produced, each containing 5 grams of polyvinyl alcohol (CELVOL® 805) that was dispersed into 50 grams of water at room temperature. The solutions were heated to 95 C to dissolve the polyvinyl alcohol. The pH of the polymer solutions of Examples 21 and 22 were adjusted to 4 and 7. The amounts of these solutions listed in Table 3 below was heated to 40° C. and poured into the polyvinyl alcohol solutions above with stirring. The final pH of these solutions was measured and are detailed in Table 3 below. The solutions were poured into individual Teflon® fluoropolymer baking pans (18×18×6 cm) and allowed to dry overnight. The resulting films were visually examined for compatibility.

The results were as follows:

TABLE 3

| | pH of the | % solids of | Amount in grams | pH of the | |
|---|---|---|---|---|---|
| | polymer | the pH | used of the pH | solution of the | |
| | solution as | adjusted | adjusted | blend of Polymer | |
| Polymer of | adjusted with | Polymer | Polymer | and polyvinyl | |
| Example | NaOH | solutions | solution | alcohol | Resulting |
| 21 | 4 | 42.5 | 11.8 | 4.2 | homogenous |
| 21 | 7 | 41.9 | 11.9 | 7.2 | inhomogeneous |
| 22 | 4 | 45 | 11 | 4.2 | homogenous |
| 22 | 7 | 42.3 | 11.8 | 7.2 | inhomogeneous |

These data indicate that films made out of a solution containing polyvinyl alcohol and an anionic water soluble hybrid or graft copolymer of pH below 5 are homogenous. However, films made with a solution containing polyvinyl alcohol and an anionic water soluble hybrid or graft copolymer of pH above 5 show signs of incompatibility of the 2 polymer components resulting in inhomogeneous films that cannot be used in commercial applications.

### Example 25

5 grams of polyvinyl alcohol (CELVOL® 805) that was mixed with 50 grams of water and heated to 95° C. to dissolve the polyvinyl alcohol. 23 grams of the polymer solution of Example 23 which was at pH 7 was heated to 40° C. and mixed with the polyvinyl alcohol solution above. The pH of the final blend solution was 7. The solution was poured into individual Teflon® fluoropolymer baking pans (18×18×6 cm) and allowed to dry overnight. The resulting film was found to a nice and homogenous and suitable for commercial applications. This experiment indicates that blends of polyvinyl alcohol and hydrophobically modified hybrid copolymers make very good films even at a neutral pH of about 7, where the anionic water soluble polymers do not form good films.

### Example 26

Automatic zero phosphate dishwash powder unit dose formulation

| Ingredients | wt % |
|---|---|
| Sodium citrate | 30 |
| Sodium carbonate | 20 |
| Copolymer of acrylic and maleic acid, sodium salt | 1 |
| Sodium disilicate | 10 |
| Perborate monohydrate | 6 |
| Tetraacetylethylenediamine | 2 |
| Enzymes | 2 |
| Sodium sulfate | 10 |

### Example 27

Automatic zero phosphate dishwash powder unit dose formulation

| Ingredients | wt % |
|---|---|
| glutamic acid N,N-diacetic acid, sodium salt | 30 |
| Sodium carbonate | 20 |
| Copolymer of acrylic and 2-acrylamido-2-methyl propane | 1 |
| sulfonic acid, sodium salt | |
| Sodium silicate | 10 |
| Sodium Perborate monohydrate | 6 |
| Tetraacetylethylenediamine | 2 |
| Enzymes | 2 |
| Sodium sulfate | 10 |

### Example 28

Automatic phosphated dishwash powder unit dose formulation

| Ingredients | wt % |
|---|---|
| Sodium tripolyphosphate | 30 |
| Sodium carbonate | 20 |
| Copolymer of acrylic and 2-acrylamido-2-methyl propane | 1 |
| sulfonic acid, sodium salt | |
| Sodium silicate | 10 |
| Sodium Perborate monohydrate | 6 |
| Tetraacetylethylenediamine | 2 |
| Enzymes | 2 |
| Sodium sulfate | 10 |

### Example 29

Laundry powder unit dose formulation

| Ingredients | wt % |
|---|---|
| Alkyl benzene sulfonate | 20 |
| Alcohol ethoxylate | 10 |
| Sodium carbonate | 20 |
| Homopolymer of acrylic, sodium salt | 1 |
| Sodium Perborate monohydrate | 5 |
| Bleach activator | 2 |
| Enzymes | 2 |
| Optical brightners | 0.5 |
| Fillers, | rest |

### Example 30

Rinse Aid unit dose formulation

| Ingredients | wt % |
|---|---|
| Low foaming Non-ionic surfactant (EO-PO block copolymer) | 50 |
| Propylene glycol | rest |

### Example 31

WP and WDG formulations that can be encased in the films of the present invention can be [symbol] in the following manner

Processing:
1. A feedstock was made with all ingredients identified below, except for the dispersant.
2. The feedstock was blended, mechanically milled and re-blended.
3. The dry dispersants were added to aliquots of the feedstock, blended, mechanically milled and blended. At this point the WP formulation is complete
4. The feedstock was transformed into dough and extruded.
5. The extrudate was dried at 50° C. for three hours to give the WDG formulation.

| Ingredients | wt % |
|---|---|
| Diuron | 82.5% |
| Naphthalene sulfonate formaldehyde condensate | 4.5% |
| Witconate AOK | 2.0% |
| Kaolin clay | 11.0% |

All documents cited in the Detailed Description of the Invention are, in relevant part, incorporated herein by reference; the citation of any document is not to be construed as an admission that it is [symbol] with respect to the present invention.

While particular embodiments of the present invention have been illustrated and described, [symbol] would be obvious to those skilled in the art that various other changes and modifications can be [symbol] without departing from the spirit and scope of the invention. It is therefore intended to cover in the appended claims all such changes and modifications that are within the scope of this invention.

We claim:

1. An aqueous, liquid composition comprising a blend of polyvinyl alcohol and a hydrophobically modified solution polymer.

2. The composition according to claim 1, comprising about 0.1 wt % or less, based on the dry weight of said blend.

3. The composition according to claim 1, wherein said hydrophobically modified solution polymer comprises from about 5% to about 95 wt % of said blend.

4. The composition of claim 1 wherein the hydrophobically modified solution polymer is derived from at least one an anionic or non-anionic ethylenically unsaturated water soluble monomer and at least one water insoluble monomer.

5. The composition of claim 1 wherein the polyvinyl alcohol is hydrolyzed polyvinyl acetate in the range of from about 80% to about 99.9 mole %.

6. The composition according to claim 4 wherein said hydrophobically modified solution polymer comprises from about 2% to about 80 wt %, based on the weight of the monomers from which said hydrophobically modified solution polymer is formed, of said at least one water-insoluble monomer.

7. The composition according to claim 1, wherein the hydrophobically modified solution polymer has a number average molecular weight of about 25,000 daltons or less, and preferably about 10,000 daltons or less.

8. The composition according to claim 1, wherein the hydrophobically modified solution polymer has a number average molecular weight of about 10,000 daltons or less.

9. The composition according to claim 1 wherein the composition has a pH of at most about 5.

10. The composition according to claim 1 wherein the composition has a pH in the range of from about 1 to about 5.

11. A method of producing a self-supporting material, comprising the steps of removing an amount of water from a liquid composition of claim 1 to 10 sufficient to form said self-supporting material.

12. A self-supporting material comprising a polyvinyl alcohol and a hydrophobically modified solution polymer, or obtainable by the method of claim 11.

13. A self-supporting material according to claim 12, wherein said polyvinyl alcohol and/or said hydrophobically modified solution polymer has less than 0.1 weight percent of crosslinker by weight of the self-supporting material.

14. An article of manufacture comprising a volume-filling formulation at least partially encapsulated by a self-supporting material of claim 12 or 13.

15. An article of manufacture according to claim 14, wherein said volume-filling formulation comprises an active ingredient selected from the group consisting of detergent active ingredients and agrochemical actives.

16. An article of manufacture according to claim 14 or 15, where in said volume-filling formulation is a liquid.

17. The article according to claim 12 or 13, wherein the self-supporting material is in the form of a film.

18. The use of a self supporting material of claim 11 or 12 as an encapsulant of a volume-filling formulation.
